(19) United States
(12) Patent Application Publication
(10) Pub. No.: US 2014/0143993 A1
(43) Pub. Date: May 29, 2014

(54) METHOD AND RETROFIT KIT FOR OSCILLATION JOINT

(71) Applicant: CATERPILLAR INC., Peoria, IL (US)

(72) Inventors: Bradley Guy Kaufman, Oreana, IL (US); Bryan D. Van Dyke, Mt. Zion, IL (US)

(73) Assignee: Caterpillar Inc., Peoria, IL (US)

(21) Appl. No.: 13/684,703

(22) Filed: Nov. 26, 2012

(51) Int. Cl. B23P 6/00

(52) U.S. Cl. CPC B23P 6/00
USPC 29/402.01; 29/33 R

(57) ABSTRACT

A method for retrofitting an oscillation joint to provide increased wear life and a kit for retrofitting an oscillation joint to provide increased wear life are provided. The method and kit include a spacer having a stop face and an axial contact face with the stop face generally smaller than the axial contact face. The spacer is sized and arranged to face a shoulder of the oscillation joint and to also support an inboard thrust bearing having a surface area greater than a surface area of the shoulder.

### TECHNICAL FIELD

The present disclosure is directed to a bearing assembly, and more particularly, to a bearing arrangement incorporating a spacer for use in an oscillation joint.

### BACKGROUND

Machines such as, for example, motor graders, wheel tractor scrapers, dozers, wheel loaders, and other types of heavy equipment are used to perform terrain-leveling tasks. These machines are often operated over uneven terrain, causing individual wheels to be displaced relative to the machine's frame as the machine's wheels track the uneven terrain. In machines with a tandem wheel drive assembly, the tandem assembly is connected to the machine via a single axle with a pair of wheels mounted to a drive housing positioned on each side of the vehicle via a pivoting or oscillation joint. The oscillation joint pivotally connects the chassis of the in relation to the outwardly positioned drive housing while enclosing the power relaying components of the drive assembly. With a known conventional suspension incorporating pivoting or oscillation joints, the machine's wheels track the terrain and the suspension is structured to manage downward as well as shear forces imparted on the wheels during machine operation. An example of a machine incorporating an oscillation joint is described in U.S. Pat. No. 7,959,169 issued to Gentry et al.

In particular, the oscillation joint is housed within an axle assembly, and is located in proximity to the differential and away from the wheels, which makes the oscillation joint prone to higher forces due to the moment arm effect between the wheels and the differential. Traditionally, the bearings within the oscillation joint consist of two vertically oriented thrust washers sandwiching a cylindrical ring bearing which is positioned between the portion of the housing enclosing the axle and the drive housing. One of the thrust bearings is generally positioned against a shoulder formed proximal to the differential side of the joint to support a portion of the joint.

Maintenance of the traditional oscillation joint typically occurs at intervals more frequent than other joints in a machine. This causes added expense and machine downtime. Moreover, the thrust washers may wear at a different rate than the one or more ring bearing resulting in additional maintenance events and the replacement of unevenly worn components. Such uneven wear often results in early replacement of the bearing combination within the oscillation joint.

The present disclosure is directed to overcoming one or more of the shortcomings set forth above.

### SUMMARY OF THE INVENTION

In an exemplary embodiment, the present disclosure is directed to a method of retrofitting an oscillation joint of a tandem drive assembly to provide increased wear life. The method includes a step of preparing a shaft attached to a machine chassis. The shaft attached to the chassis includes a cylindrical body centered about an axis extending away from the chassis and a shoulder proximal to the chassis projecting a height from the shaft in a radial direction from the axis of the shaft.

The method also includes a step of placing a spacer over the shaft. The spacer has an annular shape with a throughbore. The spacer further includes a shoulder stop face extending a first radial height substantially similar to the shoulder height and positioned abutting the shoulder, and an axial contact face disposed opposite to the stop face, the axial contact face extending a second radial height greater than the first radial height.

The method further includes a step of depositing an inboard thrust bearing adjacent the spacer axial contact face. The inboard thrust bearing includes an inner diameter, and outer diameter, and an axial bearing face. The distance between the inner diameter and the outer diameter of the inboard thrust bearing is substantially similar to the second radial height.

The method includes a step of sliding one or more ring washers over the cylindrical body of the shaft.

The method additionally includes a step of positioning a replacement oscillating hub over the shaft. The oscillating hub includes a throughbore having an inner surface rotationally positioned over the shaft. The inner surface includes a cylindrical center portion sized to rotate about the shaft and the one or more ring bearings, an inboard facing surface projecting radially from the center portion to abut an outboard facing side of the inboard thrust bearing, and an outboard facing surface projecting radially from the central portion and directed away from the chassis.

The method includes a step of depositing an outboard thrust bearing adjacent to the outboard facing surface of the oscillating hub. The outboard thrust bearing is sized substantially similar to the inboard thrust bearing.

The method also includes a step of affixing a mounting plate to an end face of the shaft. The mounting plate includes an inboard facing surface sized and adapted for facing an end surface of the shaft and an outboard facing surface of the outboard thrust bearing, and one or more mounting holes for fixing the mounting plate to the end of the shaft.

In an exemplary embodiment, the present disclosure is directed to a kit for retrofitting an oscillation joint of a tandem drive assembly to provide an increased wear life. The kit includes a spacer including an annular shape, a throughbore centered about an axis, a stop face extending a first radial height perpendicular to the axis, and an axial contact face disposed opposite the stop face extending a second radial height perpendicular to the axis, the second radial height being greater than the first radial height. The kit also includes an inboard thrust bearing including an inner diameter, an outer diameter, and an axial bearing face. The distance between the inner diameter and the outer diameter is substantially similar to the second radial height.

### BRIEF DESCRIPTION OF THE DRAWINGS

FIG. 1 is a diagrammatic illustration of an exemplary machine;

FIG. 2 is a perspective view of a lower drive train assembly of the machine of FIG. 1 with drive casing in section;

FIG. 3 is a partial bottom view of the machine of FIG. 1 specifically directed to the tandem wheel lower drive train assembly therein;

FIG. 4 is a cross section of an exemplary oscillation joint within the drive train assembly of FIG. 3;

FIG. 5 is a perspective view of a spacer of the oscillation joint of FIG. 4;

FIG. 6 is a cross-sectional view of a the spacer of FIG. 5 about line A-A;

FIG. 7 is a sectional perspective view of the exemplary oscillation joint of the drive assembly shown in FIG. 3; and

FIG. 8 is a flow chart for a method of retrofitting an oscillation joint.

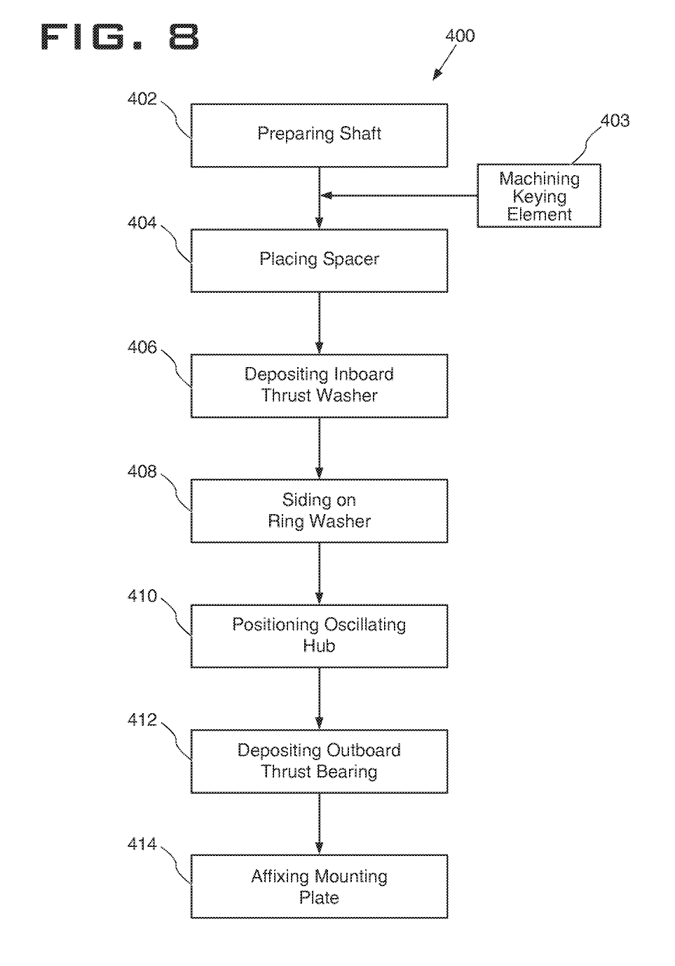

### DETAILED DESCRIPTION

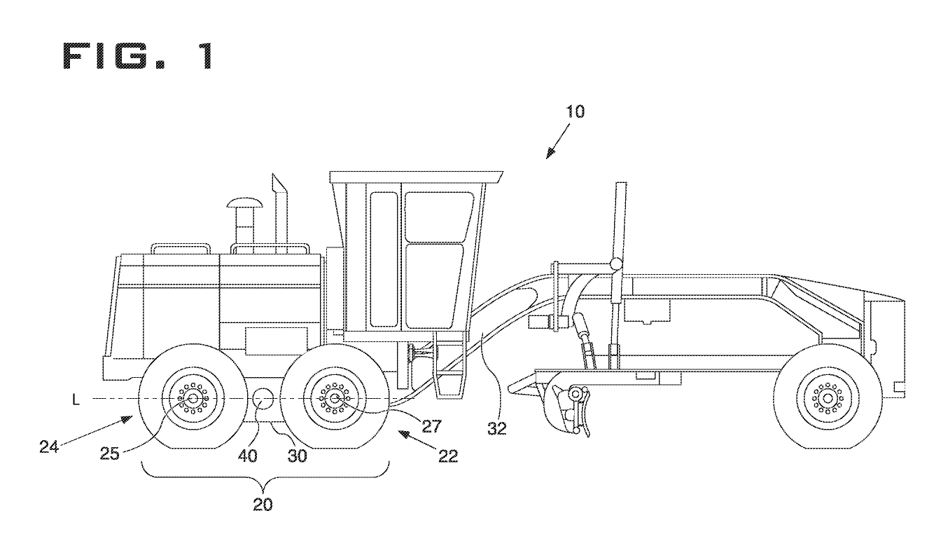

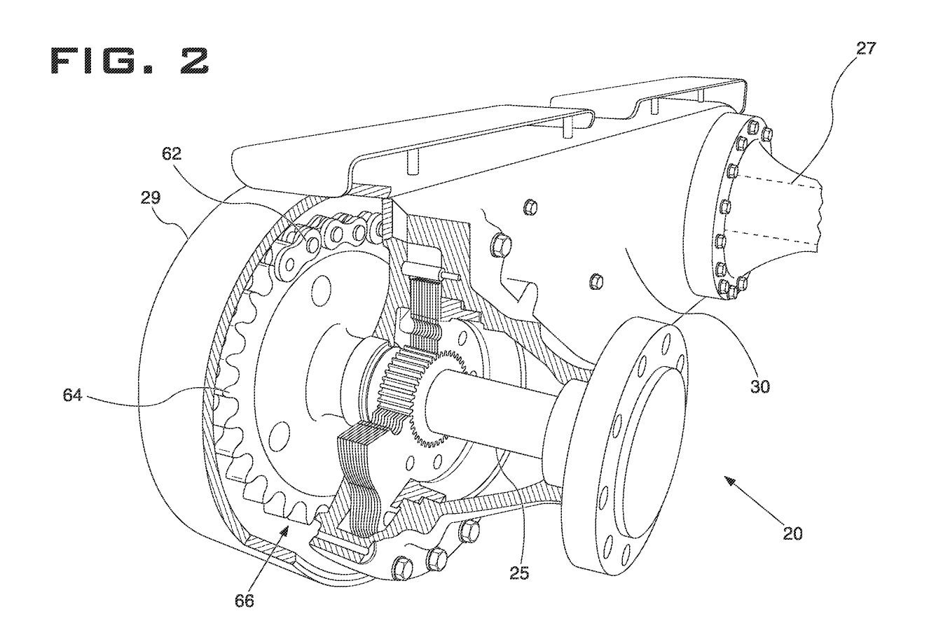

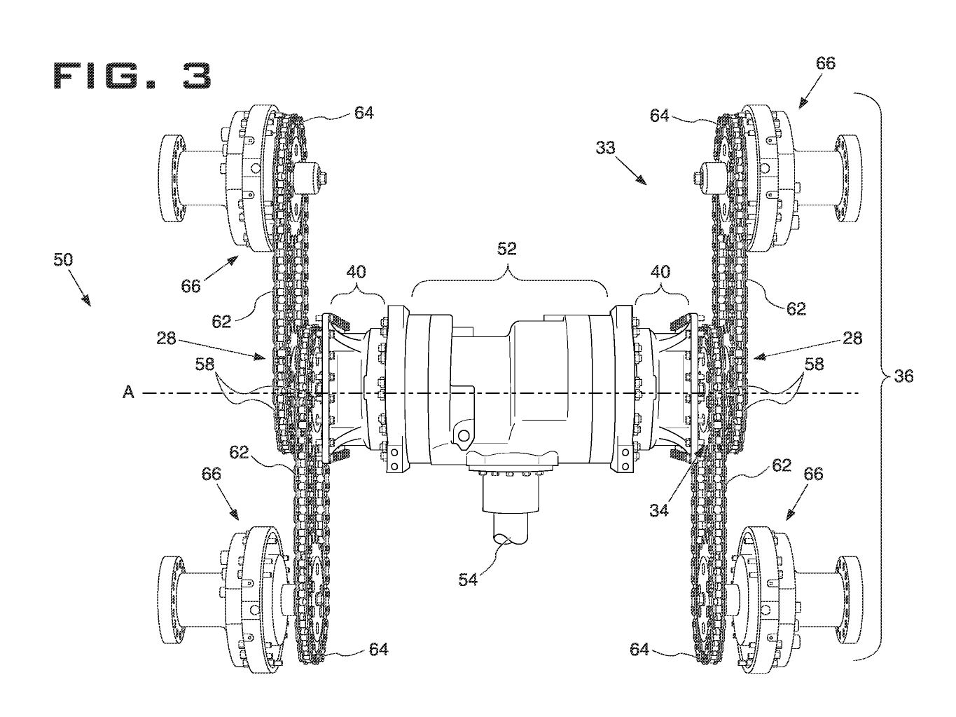

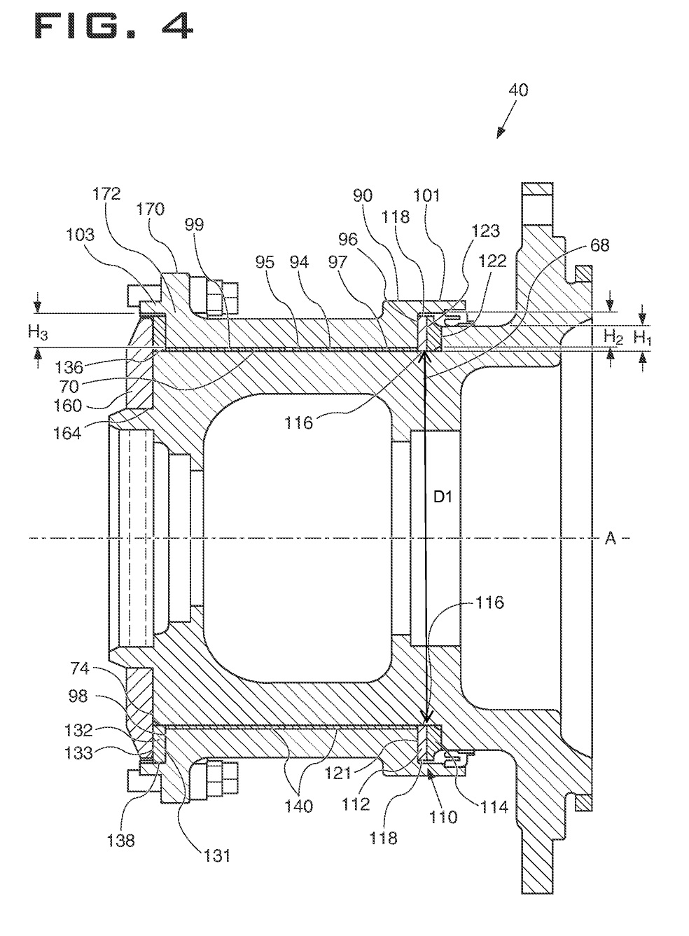

FIG. 1 illustrates machine 10 having a tandem wheel drive 20 which includes forward wheel 22 and rear wheel 24. The wheels are connected to rear and front axles 25, 27 and in turn, axles 27, 25 are rotatably supported within lower drive train assembly 50. Lower drive train assembly 50 includes drive casing 30, which is best seen in FIG. 2, however drive casing 30 has been removed in FIG. 3 to better show the drive and wheel assembly aspects. Drive casing 30 is a rigid structure that supports rotating rear and front axles 25, 27. Positioned on inner side 29 of casing 30 is hub assembly 90 (FIGS. 3 and 4) which is rotatably connected to shaft 68 (FIG. 4) of the axle assembly 28 through oscillation joint 40. The forward wheel 22 is positioned forward of the oscillation joint 40 relative to the machine 10 and the rear wheel 24 is positioned to the rear of the oscillation joint 40. While FIG. 1 depicts the right side of the machine 10, an identical tandem wheel drive 20 would be provided on the left side as well.

FIG. 3 depicts the lower drive train assembly 50 of the tandem wheel drive 20. The lower drive train assembly 50 includes centrally located differential 52 connected to drive shaft 54 which is in turn driven by a power source, such as an engine (not shown). Extending from each side of the differential 52 are drive axles 56. In an exemplary embodiment, drive axle 56 has chain drive sprocket 58 affixed to an end of the drive axle 60. Each chain drive sprocket 58 drives a chain loop 62, which in turn drives a wheel sprocket 64 associated with each wheel assembly 66. Rotation of the drive shaft 54 provides power to the differential 52, which in turn drives the rotation of a drive axle 56 which rotates about a central axis that substantially corresponds to the oscillation joint axis A.

FIG. 4 depicts a sectional view of an exemplary oscillation joint 40. The oscillation joint 40 includes a shaft portion 68 having a cylindrical outer surface section 70 that surrounds and is centered about oscillation joint axis A. In one embodiment, the shaft portion 68 has a diameter D₁ of about 225 mm to about 725 mm in the area of the cylindrical outer surface section 70.

The cylindrical outer surface has a first end 72 proximal to the differential 52 and a second end distal to the differential having an end face 74 projecting perpendicular and radially inwardly from the cylindrical outer surface 70. In the embodiment depicted in FIG. 4 a shoulder 76 extends perpendicularly and radially outward from the cylindrical surface 70 of the first end 72 of the shaft 68. The shoulder 76 extends a height H₁ of about 15 mm to about 50 mm between the cylindrical surface 70 and a top edge 78. The shoulder substantially extends around the circumference of the inner housing 68 and has a diameter greater than that of the cylindrical outer surface 70. The inner housing 69, which includes shaft 68 and shoulder 76, may additionally include a flange surface 80 for fixedly connecting the inner housing 69 to the differential 52. The flange surface 80 may be connected to the differential 52 using bolts, screws, welding, or any other known method of fixedly attaching pieces together. By fixedly attached, it is intended that the inner housing and the differential do not rotate relative to one another. The inner housing may also be provided with a second cylindrical surface 82 extending from the shoulder top edge 78 to the flange 80 joining the structures.

Positioned over and surrounding the cylindrical outer surface 70 is an oscillating hub 90 having a throughbore forming an inner contact surface 94. The oscillating hub 90, when its inner contact surface 94 is positioned over the outer surface 70, is rotatable relative to the shaft portion 68. The inner contact surface 94 of the oscillating hub 90 is provided with a cylindrical center portion 95 sized to rotate over the shaft 68. The inner contact surface 94 is also provided with an inboard facing surface 96 projecting radially outward from an inboard side 97 of the cylindrical central portion 95 such that, in use, the inboard facing surface 96 is positioned facing toward the shoulder 76. The inboard facing surface 96 extends a height H₂ radially away from the cylindrical central portion 95. The inboard facing surface 96 may be bounded at an upper edge by an inboard cylindrical flange 101 extending axially away from the inboard facing surface 96 and cylindrical central portion 95.

The inner contact surface 94 is also provided with an outboard facing surface 98 projecting radially outward from an outboard side 99 of the cylindrical central portion 95 such that, in use, the outboard facing side 98 is positioned facing away from the shoulder 76. The outboard facing surface 98 extends a height H₃ radially away from the cylindrical central portion 95. The outboard facing surface 98 may be bounded at an upper edge by an outboard cylindrical flange 103 extending axially away from the outboard facing surface 98 and cylindrical central portion 95.

The outboard cylindrical flange 103 of oscillating hub 90 is also provided with an outer flange 170 positioned at the outboard side 172 of the oscillating hub 90. The outer flange 170 is provided so that the oscillating hub 90 can be fixedly connected to the drive casing 30. The oscillating hub 90 may be connected to the drive casing 30 using a fastening device 174 such as bolts, screws, or any other known method of fixedly attaching pieces together.

The oscillation joint 40 may further be provided with an annular mounting plate 160 sized to interact with an end face 74 of the shaft and to hold the oscillating hub 90 in place. In other words, the mounting plate may be sized to extend radially up to the outboard cylindrical flange 103 of the oscillating hub 90. The mounting plate 160 may be fixedly held in place by a fastening device 162 such as a bolt or screw. The mounting plate 160 has a central through hole 164 sized to allow the drive axle 56, which passes through the hollow portion of the shaft 68, to pass through the mounting plate 160 as well.

Positioned between the shoulder 76 of the inner housing 69 and the oscillating hub 90 of the oscillation joint 40 is a thrust bearing arrangement 110. The thrust bearing arrangement 110 includes an inboard thrust bearing 112 and a spacer 114. The inboard thrust bearing 112 includes an inner diameter 116, an outer diameter 118, and an axial bearing face 121 disposed therebetween. The axial face 121 has an effective bearing surface area which is the extent of the thrust bearing that is generally acted upon in the bearing arrange 110. This tends to be the portion of the thrust bearing that is radially outward of the inner diameter 116. The inboard thrust bearing 112 may have an inner diameter 116 of about 225 mm to about 725 mm. The inboard thrust bearing may have an outer diameter 118 of about 255 mm to about 825 mm. The effective surface area of the inboard thrust bearing is generally in the range of 11,310 mm² to about 121,737 mm². Generally, the ratio of the inner diameter of the bearing 116 to the effective surface area of the bearing is in the range of about 1:50 to about 1:168. In use, the inboard thrust bearing 112 axial bearing face 121 is positioned to be the outboard facing side. The inboard bearing 112 also has an opposing face 123 positioned on the side opposite the axial bearing face 121. In an exemplary embodiment, the shoulder 76 has a surface area and the effective surface area of the inboard thrust bearing is 130 to 220% greater than the shoulder surface area.

The inboard thrust bearing 112, and any other bearings discussed herein, may be formed from materials selected from phenolic cotton, phenolic Kevlar, glass filled nylon, polyether ether ketone, and mixtures thereof. Preferably, the thrust bearing is formed from phenolic cotton. However, the bearings discussed herein may be formed from any bearing material known in the art.

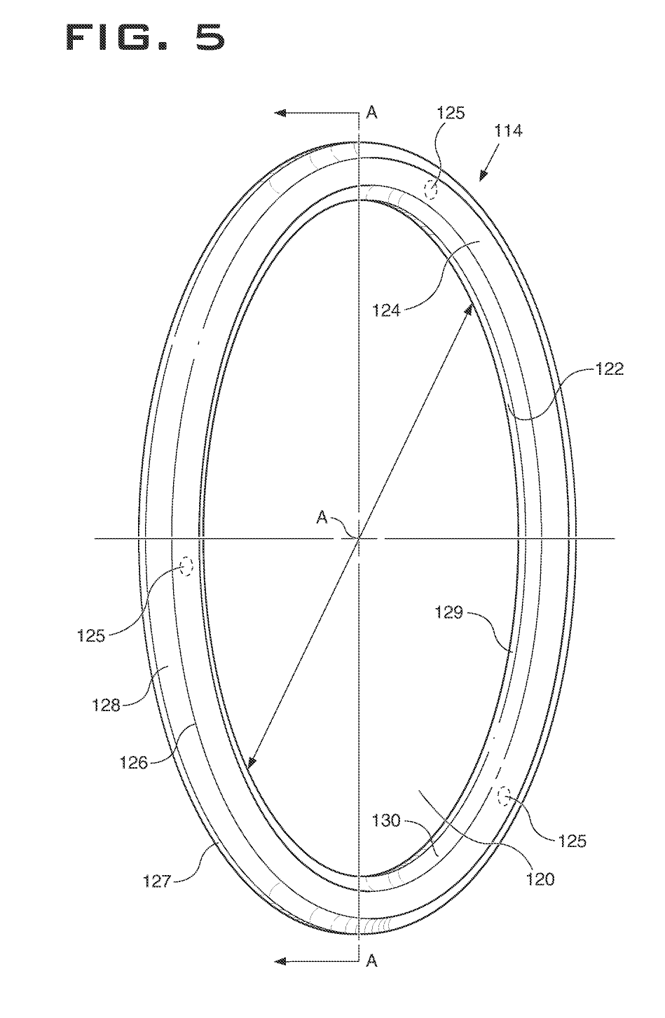

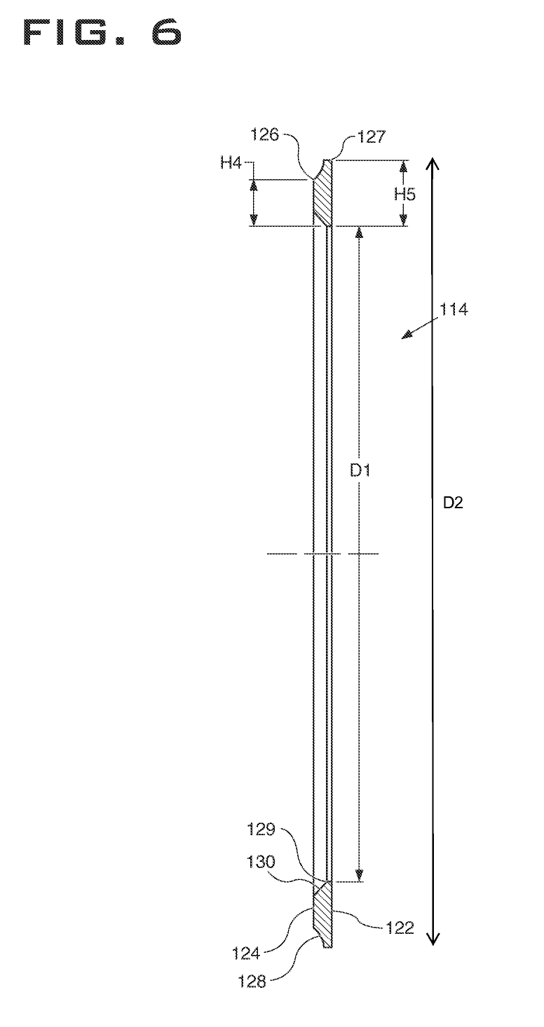

FIGS. 5 and 6 depict a spacer 114 for use in an oscillation joint 40. The spacer 114 is annular in shaped and is generally centered around a central axis A. The spacer has a throughbore 120 with a diameter at its narrowest that is roughly equivalent to the diameter of the shaft 68 such that the spacer 114 can be positioned over the shaft 68. The spacer is also provided with an axial contact face 122 and a stop face 124 having a support surface opposite the axial contact face 122. Both the axial contact face 122 and the stop face 124 are perpendicular the axial direction of the throughbore. As depicted the support surface of the stop face 124 of the spacer 114 is smaller relative to the axial contact face 122. In the context of the thrust bearing assembly 110, the inboard thrust bearing 112 overlays the axial contact face 122 of the spacer 114. In an exemplary embodiment, the inboard thrust bearing 112 and axial contact face 122 are matched such that they have similar inner diameters and outer diameters such that the inboard thrust bearing 112 is supported along its inboard surface area by the axial contact face 122 of the spacer 114.

The spacer 114 has an inner diameter D₁ measured at the narrowest opening of the throughbore 120 and an outer diameter D₂. The outer portion of the stop face 124 extends a first radial height H₄ from the narrowest portion of the throughbore 120 to a first outer edge 126 and the axial contact face 122 extends a second height H₅ to a second outer edge 127. The second radial height H₅ is relatively larger than the first radial height H₄. In use, the first radial height is substantially the same as the height H₁ of the shoulder 76 and the second radial height H₅ is substantially the same as the distance between the inner diameter 116 and outer diameter 118 of the inboard thrusts bearing 112. Thus the spacer 114 is supported by the shoulder 76 and fully supports an inboard thrust bearing 112 that is larger than a thrust bearing which could effectively be supported by the shoulder alone. The diameter D₁ may be about 225 mm to about 725 mm.

Extending between the first outer edge 126 and second outer edge 127 of the spacer 114 is an outer sidewall 128. The shape of the outer sidewall 128 may be a radius cut, a straight line or a chamfer. The shape of the outer sidewall 128 as shown in FIG. 6 is a radius cut, but any outer sidewall shape that provides sufficient support to carry the loads from the axial contact face 122 to the stop face 124 and shoulder 76 is appropriate.

In an exemplary embodiment, the throughbore 120 may have a cylindrical area 129 proximal to the axial support face 122 having a diameter D₁. The throughbore 120 may also have a frustoconical area 130 proximal to the stop face 124. This frustoconical area 130 is provided so that, in use, there is sufficient clearance for the spacer 114 at the junction of the shaft 68 and shoulder 76 so that the stop face 124 can directly abut the shoulder 76.

In another exemplary embodiment, the spacer may be provided with one or more keying elements 125 to prevent rotation of the spacer 114 relative to the oscillation joint 40. The spacer keying element 125 may be, for example, in the form of a projection, a detent, or another geometry formed on the spacer 114 that would prevent rotation relative to the shoulder 76.

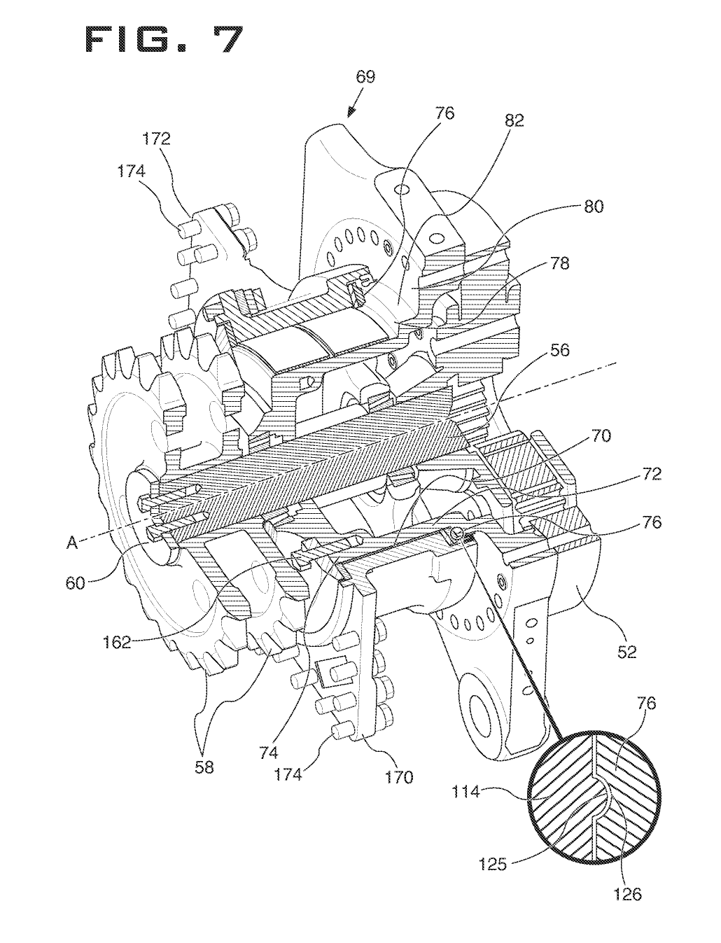

As depicted in FIG. 7, the shoulder 76 may similarly be provided with a corresponding keying element 126 that locks with the spacer keying element 125. The shoulder keying element may take the form of the complementary projection, detent or similar geometry that will prevent the spacer 114 from rotation relative to the shoulder. By providing complementary keying elements 125, 126 to prevent rotation of the spacer 114 relative to the shoulder 76, the possibility of unwanted wear to the spacer 114 and/or the shoulder 76 can be reduced or avoided.

The spacer 114 described herein may be provided such that the first radial height H₄ associated with the stop face 124 is about 240 mm to about 775 mm. The second radial height H₅ associated with the axial contact face 122 of the spacer 114 is about 255 mm to about 825 mm.

The disclosed spacer 114 may be formed from a support material having a relative hardness greater then material of the inboard bearing 112. It is contemplated that the spacer 114 may be formed from a metallic material such as steel, iron, brass, or bronze.

In an exemplary embodiment, a tandem power train assembly 50 is provided. The tandem power train assembly generally includes an input member, such as a drive axle 56, that is mechanically connected to a tandem output assembly. The tandem output assembly may be in the form of the drive casing 30 that supports the tandem wheel assembly 20. The tandem power train assembly 50 also includes an oscillation joint 40 drivingly coupled to the input member. By drivingly coupled, it is meant that the input member, namely the drive axle 56 is supported by and passes through the oscillation joint 40. This arrangement allows the input member to transmit rotation to the tandem output assembly, namely, to the components of the drive casing 30 through the oscillation joint 40. The oscillation joint 40 is also structured and arranged to rotatably support the tandem output assembly relative to the machine 10.

The oscillation joint 40 includes a shaft 68 attached to a chassis 32. The chassis 32, as described above, supports a lower drive train assembly 50 that includes centrally located differential 52 connected to drive shaft 54 which is in turn driven by a power source, such as an engine (not shown). Extending from each side of the differential 52 are input members, such as drive axles 56. The shaft 68 includes a shoulder 76 positioned proximal to the chassis 32. The shoulder projects a height H₁ from the shaft 68 in a radial direction from the axial direction A of the shaft.

The oscillation joint 40 of this exemplary embodiment further includes a spacer 114. As described above, the spacer 114 has an annular shape having a throughbore 120. The throughbore 120 is sized and arranged to slidingly fit over the shaft 68 during assembly. The spacer 114 includes a stop face 124 extending a first height H₄ as described above. The height H₄ of the stop face 124 is substantially similar to the height H₁ of the shoulder 76. The spacer further includes an axial contact face 122 disposed opposite the stop face 124 and extending a second radial height H₅ greater than the stop face height H₄. The spacer is positioned in the oscillation joint 40 such that the stop face 124 is adjacent the shoulder 76.

The oscillation joint 40 further includes a plurality of bearings. At least one of the bearings is an inboard thrust bearing 112 positioned adjacent the axial contact face 122 of the spacer 114. As described above, the inboard thrust bearing 112 including an inner diameter 116, an outer diameter 118, and an axial bearing face 121. The distance between the inner diameter 116 and the outer diameter 118 is substantially similar to the spacer axial contact face height H₅.

The tandem power train assembly may further include an oscillating hub 90 mounted to the tandem output assembly. As described above, the oscillating hub is positioned over and surrounds the cylindrical outer surface 70 of the shaft 68. The oscillating hub 90 includes a throughbore forming an inner contact surface 94. The oscillating hub 90, when its inner contact surface 94 is positioned over the outer surface 70, is rotatable relative to the shaft portion 68. The inner contact surface 94 of the oscillating hub 90 is provided with a cylindrical center portion 95 sized to rotate over the shaft 68. The inner contact surface 94 is also provided with an inboard facing surface 96 projecting radially outward from an inboard side 97 of the cylindrical central portion 95 such that, in use, the inboard facing surface 96 is positioned facing toward the shoulder 76. The inboard facing surface 96 extends a height H₂ radially away from the cylindrical central portion 95. The inboard facing surface 96 may be bounded at an upper edge by an inboard cylindrical flange 101 extending axially away from the inboard facing surface 96 and cylindrical central portion 95.

Positioned between the cylindrical outer surface 70 of the shaft 68 and the cylindrical center 95 of the oscillating hub 90 may be one or more ring bearings 140. The rings bearings 140 are generally cylindrical in shape, sized and arranged to fit over the cylindrical surface 70 of the shaft 68, and to provide a wearable bearing surface between the shaft 68 and the oscillating hub 90.

The inner contact surface 94 is also provided with an outboard facing surface 98 projecting radially outward from an outboard side 99 of the cylindrical central portion 95 such that, in use, the outboard facing side 98 is positioned facing away from the shoulder 76. The outboard facing surface 98 extends a height H₃ radially away from the cylindrical central portion 95. The outboard facing surface 98 may be bounded at an upper edge by an outboard cylindrical flange 103 extending axially away from the outboard facing surface 98 and cylindrical central portion 95.

The outboard cylindrical flange 103 of oscillating hub 90 is also provided with an outer flange 170 positioned at the outboard side 172 of the oscillating hub 90. The outer flange 170 is provided so that the oscillating hub 90 can be fixedly connected to the drive casing 30. The oscillating hub 90 may be connected to the drive casing 30 using a fastening device 174 such as bolts, screws, or any other known method of fixedly attaching pieces together.

Positioned axially away from the shoulder 76 is an outboard thrust bearing 132. The outboard thrust bearing 132 is sized substantially similar to the inboard thrust bearing 112, such that the inner diameter 136, outer diameter 138, and axial face 131 of the outboard thrust bearing 132 correspond to the related inner diameter 116, outer diameter 118, and axial face 121 of the inboard thrust bearing 112. In use, the outboard thrust bearing 132 axial bearing face 131 is positioned to be the inboard facing side. The outboard bearing 132 also has an opposing face 133 forming an outboard facing side positioned on the side opposite the outboard axial bearing face 131.

The tandem power train assembly may additionally be provided with an annular mounting plate 160 sized to interact with an end face 74 of the shaft and to hold the oscillating hub 90 in place. In other words, the mounting plate may be sized to extend radially up to the outboard cylindrical flange 103 of the oscillating hub 90. The mounting plate 160 may be fixedly held in place by a fastening device 162 such as a bolt or screw. The mounting plate 160 has a central through hole 164 sized to allow the drive axle 56, which passes through the hollow portion of the shaft 68, to pass through the mounting plate 160 as well.

In an exemplary embodiment, a kit for retrofitting an oscillation joint 40 for a tandem drive assembly 20 having a shaft 68 to provide increase wear life is described. The kit may include a spacer 114 and an inboard thrust bearing 112 as described above. Briefly, the spacer 114 includes an annular shape and a throughbore 120. The throughbore 120 is sized and arranged to slidingly fit over the shaft 68. Briefly, the spacer 144 has a shoulder stop face 124 extending a first radial height H₄ substantially similar to the shoulder height H₁. The spacer 144 also includes an axial contact face 122 disposed opposite to the stop face 124. The axial contact face 122 extends a second height H₅ greater than the first height H₄. The inboard thrust bearing 112 includes an inner diameter 116, an outer diameter 118, and an axial bearing face 121. The distance between the inner diameter 116 and the outer diameter 118 is substantially similar to the second height H₅.

The kit may also include an outboard thrust bearing 132 sized substantially similar to the inboard thrust bearing.

The kit may additionally include an oscillating hub 90. The oscillating hub 90, as described above, includes a throughbore forming an inner contact surface 94. The oscillating hub 90, when its inner contact surface 94 is positioned over the outer surface 70, is rotatable relative to the shaft portion 68. The inner contact surface 94 of the oscillating hub 90 is provided with a cylindrical center portion 95 sized to rotate over the shaft 68. The inner contact surface 94 is also provided with an inboard facing surface 96 projecting radially outward from an inboard side 97 of the cylindrical central portion 95 such that, in use, the inboard facing surface 96 is positioned facing toward the shoulder 76. The inboard facing surface 96 extends a height H₂ radially away from the cylindrical central portion 95. The inboard facing surface 96 may be bounded at an upper edge by an inboard cylindrical flange 101 extending axially away from the inboard facing surface 96 and cylindrical central portion 95. The inner contact surface 94 is also provided with an outboard facing surface 98 projecting radially outward from an outboard side 99 of the cylindrical central portion 95 such that, in use, the outboard facing side 98 is positioned facing away from the shoulder 76. The outboard facing surface 98 extends a height H₃ radially away from the cylindrical central portion 95. The outboard facing surface 98 may be bounded at an upper edge by an outboard cylindrical flange 103 extending axially away from the outboard facing surface 98 and cylindrical central portion 95.

The inboard facing surface height H₂ is substantially similar to the second radial height H5 of the spacer 114. In this instance, the height H₂ may be slightly higher than the height H₅ to allow rotational spacer between the upper edge of the spacer 114 and the inboard cylindrical flange 101 of the oscillating hub 90. The outboard facing surface height H₃ is also substantially similar to the second radial height H₅ of the spacer 114.

The kit may also include a mounting plate 160. The mounting plate 160 is sized to interact with an end face 74 of the shaft and serves to hold the oscillating hub 90 in place. In other words, the mounting plate may be sized to extend radially up to the outboard cylindrical flange 103 of the oscillating hub 90. The mounting plate 160 may be fixedly held in place by a fastening device 162 such as a bolt or screw. The mounting plate 160 has a central through hole 164 sized to allow the drive axle 56, which passes through the hollow portion of the shaft 68, to pass through the mounting plate 160 as well.

### Industrial Applicability

As described above, the oscillation joint 40 allows independent rotation of the drive casing 30 about the oscillation joint axis A. The rotation about the oscillation joint 40 allows the machine 10 to operate more smoothly over rough terrain. For example, when the machine 10 is moving in a forward direction and the right side forward wheel 22 as depicted in FIG. 1 encounters an obstacle, such as a rock, the forward wheel would move upwardly and cause a counterclockwise rotation of the drive casing 30 about the oscillation joint axis A. When the forward wheel 22 is on the rock, the axle of the forward wheel 23, oscillation joint axis A, and the axle of the rear wheel 25 remain in a straight line L with the front wheel elevated relative to the rear wheel 24. As the forward wheel 22 passes over and drops back down from the rock, the drive casing 30 rotates clockwise about the oscillation joint axis A until the line L is again substantially horizontal (or parallel with the ground). When the rear wheel 24 then encounters the rock, the rear wheel 24 would, in a manner similar to the forward wheel 22, move upwardly and cause a clockwise rotation of the drive casing 30 about the oscillation joint axis A. When the rear wheel 24 is on the rock, the axle of the forward wheel 23, oscillation joint axis A, and the axle of the rear wheel remain in a straight line L with the rear wheel 24 elevated relative to the forward wheel 22. As the rear wheel 24 passes over and drops down from the rock, the drive casing rotates counterclockwise about the oscillation joint axis A until the line L is substantially horizontal. The rotation of the oscillation joint 40 when the wheel 22, 24 are passing over obstacles also allows more accurate terrain leveling operation.

It has been found that having a thrust bearing that has a larger outer diameter 118 will provide a longer service life as the effective bearing surface area of the is increased when the outer diameter 118 of the inboard thrust bearing 112 is increased. However, the height of the shoulder 76 in existing machines has traditionally limited the outer diameter of inboard thrust bearings as these bearing have historically been supported by the shoulder. The introduction of a spacer 114 as described herein provides a modified surface that contacts the shoulder 76 and supports the inboard thrust bearing 112 such that the total surface area of the inboard thrust bearing 112 is greater than the total surface area of the shoulder 76. By utilizing the thrust bearing arrangement 110 incorporating the inboard thrust bearing 112 and spacer 114, the effective surface area of the bearing is greater than a bearing that would have been supported by the shoulder alone.

FIG. 7 depicts a section of a portion of the oscillation joint 40. In an exemplary embodiment, the drive axle 56 passes through a shaft portion 68 of the oscillation joint 40. As described above, the shaft 68 has a cylindrical outer surface 70 that surrounds and is centered about oscillation joint axis A. The cylindrical outer surface has a first end 72 proximal to the differential 52 and a second end distal to the differential have an end face 74 projecting perpendicular and radially inwardly from the cylindrical outer surface 70. In the embodiment depicted in FIGS. 4 and 7 and described above, extending perpendicular and radially outward from the cylindrical surface 70 from the first end 72 is a shoulder wall 76 between the cylindrical surface 70 and a top edge 78. The shoulder substantially extends around the circumference of the inner housing 68 and has a diameter greater than that of the cylindrical outer surface 70. The inner housing 69, which includes shaft 68 and shoulder wall 76, additionally includes a flange surface 80 for fixedly connecting the inner housing 69 to the differential 52. The flange surface 80 may be connected to the differential 52 using bolts, screws, welding, or any other known method of fixedly attaching pieces together. By fixedly attached, it is intended that the inner housing and the differential do not rotate relative to one another. The inner housing may also be provided with a second cylindrical surface 82 extending from the shoulder top edge 78 to the flange 80 joining the structures.

The disclosed oscillation joint and bearing assembly may be an inexpensive, effective solution for reducing bearing wear in the oscillation joint of a machine.

In an exemplary embodiment, the present disclosure provides a method 400 of retrofitting an oscillation joint 40 of a tandem drive assembly 20 to provide increased wear life. The method includes a step of preparing 402 the shaft 68 of the machine 10, the shaft being attached to the machine chassis 32. The shaft 68 as described above, includes a cylindrical boy 70 extending away from the chassis 32, and a shoulder 76 positioned on the shaft 68 proximal to the chassis 32. The shoulder 76 projects a height H₁ in a radial direction from the axis A of the shaft 68. Generally, the step of preparing the shaft 68 includes removing the existing oscillating hub as well as any thrust bearings and ring bearings from the shaft. This step may also include the removal of any lubricant/debris seals (not shown) that seal the oscillation joint 40.

The method includes a step of placing 404 a spacer 114 including an annular shape and a throughbore 120, as described above, over the shaft 68. The throughbore 120 is sized and arranged to slidingly fit over the shaft 68. Briefly, the spacer 144 has a shoulder stop face 124 extending a first radial height H₄ substantially similar to the shoulder height H₁. The spacer 144 also includes an axial contact face 122 disposed opposite to the stop face 124. The axial contact face extends a second height H₅ greater than the first height H₄. As discusses above, the spacer 114 may also include a keying element 125 to prevent rotation of the spacer 114 relative to the shoulder 76.

Prior to the step of placing 404 the spacer 114, a step of machining 403 one or more detents 126 into the shoulder 76 may be performed. Correspondingly, the spacer 114 may be provided with a similar number of projections 125 that will nest into the detents 126 and prevent rotation of the spacer.

The method also includes a step of depositing 406 an inboard thrust bearing 112 adjacent to the spacer axial contact face 122. As described above, the inboard thrust bearing 112 includes an inner diameter 116, an outer diameter 118, and an axial bearing face 121. The distance between the inner diameter 116 and the outer diameter 118 is substantially similar to the second height H₅. By substantially similar, it is meant that the measurements are approximately the same. Preferably, the inboard thrust washer 112 is completely supported by the spacer 114. As described above, the inboard bearing 112 also has an opposing face 123 positioned on the side opposite the axial bearing face 121. In use, the opposing face 123 is positioned in contact with the spacer axial contact face 122 and the axial bearing face 121 of the inboard thrust bearing 112 faces away from the chassis 32.

The method also includes a step of sliding 408 one or more ring washers 140 over the cylindrical body 70 of the shaft 68. The rings bearings 140 are generally cylindrical in shape, sized and arranged to fit over the cylindrical surface 70 of the shaft 68, and to provide a wearable bearing surface between the shaft 68 and the oscillating hub 90.

The method further includes a step of positioning 410 a replacement oscillating hub 90 over the shaft 68. As discussed above, the oscillating hub 90 has a throughbore forming an inner contact surface 94. The oscillating hub 90, when its inner contact surface 94 is positioned over the outer surface 70, is rotatable relative to the shaft portion 68. The inner contact surface 94 of the oscillating hub 90 is provided with a cylindrical center portion 95 sized to rotate over the shaft 68 and the one or more ring bearings 140. The inner contact surface 94 is also provided with an inboard facing surface 96 projecting radially outward from an inboard side 97 of the cylindrical central portion 95 such that, in use, the inboard facing surface 96 is positioned facing toward the shoulder 76. The inboard facing surface 96 extends a height H₂ radially away from the cylindrical central portion 95. The inboard facing surface height H₂ is substantially similar to the second radial height H₅ of the spacer 114. In this instance, the height H₂ may be slightly greater than the height H₅ to allow rotational spacer between the upper edge of the spacer 114 and the inboard cylindrical flange 101 of the oscillating hub 90. The inboard facing surface 96 may be bounded at an upper edge by an inboard cylindrical flange 101 extending axially away from the inboard facing surface 96 and cylindrical central portion 95.

The inner contact surface 94 is also provided with an outboard facing surface 98 projecting radially outward from an outboard side 99 of the cylindrical central portion 95 such that, in use, the outboard facing side 98 is positioned facing away from the shoulder 76. The outboard facing surface 98 extends a height H₃ radially away from the cylindrical central portion 95. The outboard facing surface 98 may be bounded at an upper edge by an outboard cylindrical flange 103 extending axially away from the outboard facing surface 98 and cylindrical central portion 95. The outboard facing surface height H₃ is substantially similar to the second radial height H₅ of the spacer 114.

The method additionally includes a step of depositing 412 an outboard thrust bearing 132 adjacent to the outboard facing surface 98 of the oscillating hub 90. The outboard thrust bearing 132 is, as described above, sized substantially similar to the inboard thrust bearing 112.

The replacement oscillating hub 90 may be provided by machining an existing oscillating hub to have the required measurements and surfaces described herein. For example, the existing oscillating hub may be machined to provide an inboard facing surface 96 and an outboard facing surface 98 having heights of H₂ and H₃ respectively, or in other words, heights substantially similar to H₂. Alternatively, the replacement oscillating hub 90 may be newly manufactured.

The method includes a step of affixing 414 a mounting plate 160 to an end 74 of the shaft 68. The annular mounting plate 160 is sized to interact with an end face 74 of the shaft and serves to hold the oscillating hub 90 in place. In other words, the mounting plate may be sized to extend radially up to the outboard cylindrical flange 103 of the oscillating hub 90. The mounting plate 160 may be fixedly held in place by a fastening device 162 such as a bolt or screw. The mounting plate 160 has a central through hole 164 sized to allow the drive axle 56, which passes through the hollow portion of the shaft 68, to pass through the mounting plate 160 as well.

It will be apparent to those skilled in the art that various modifications and variations may be made to the disclosed thrust bearing arrangement, spacer and tandem power train assembly. Other embodiments will be apparent to those skilled in the art from consideration of the specification and practice of the disclosed thrust bearing arrangement, spacer and tandem power train assembly. It is intended that the specification be considered as exemplary only, with a true scope being indicated by the following claims and their equivalents.

What is claimed is:

1. A method of retrofitting an oscillation joint of a tandem drive assembly to provide increased wear life, the method comprising the steps of:
preparing a shaft attached to a machine chassis, the shaft comprising a cylindrical body centered about an axis extending away from the chassis and a shoulder proximal to the chassis projecting a height in a radial direction from the axis of the shaft;
placing a spacer comprising an annular shape with a throughbore positioned over the shaft, a shoulder stop face extending a first radial height substantially similar to the shoulder height and positioned abutting the shoulder, and an axial contact face disposed opposite to the stop face, the axial contact face extending a second radial height greater than the first radial height;
depositing an inboard thrust bearing adjacent the spacer axial contact face, the thrust bearing comprising an inner diameter, an outer diameter, and an axial bearing face, wherein a distance between the inner diameter and outer diameter is substantially similar to the second radial height;
sliding one or more ring washers over the cylindrical body of the shaft;
positioning a replacement oscillating hub over the shaft, the oscillating hub comprising a throughbore having an inner surface rotatably positioned over the shaft, the inner surface of the throughbore comprising a cylindrical central portion sized to rotate about the shaft and the one or more ring bearings, an inboard facing surface projecting radially from the central portion to abut an outboard facing side of the inboard thrust bearing, and an outboard facing surface projecting radially from the central portion and directed away from the chassis;
depositing an outboard thrust bearing adjacent to the outboard facing surface of the oscillating hub, the outboard thrust bearing sized substantially similar to the inboard thrust bearing; and
affixing a mounting plate to an end face of the shaft, the mounting plate comprising an inboard facing surface sized and adapted for facing an end surface of the shaft and an outboard facing surface of the outboard thrust bearing, and one or more mounting holes for fixing the mounting plate to the end of the shaft.

2. The method of claim 1, wherein the step of preparing the shaft includes removing an existing oscillating hub, and removing any thrust bearings and ring bearings from the shaft.

3. The method of claim 1, wherein the inboard facing surface and outboard facing surface of the replacement oscillating hub each have a radial height substantially similar to the second radial height.

4. The method of claim 3, wherein an existing oscillating hub is machined to modify the inboard facing surface and the outboard facing surface to the second radial heights to provide the replacement oscillating hub.

5. The method of claim 1, wherein the replacement oscillating hub is newly manufactured.

6. The method of claim 1, wherein the axial bearing face includes an effective surface area and the ratio of the shoulder height to the effective surface area is about 1:50 to about 1:168.

7. The method of claim 1, wherein the spacer further comprises a keying element for preventing rotation of the spacer relative to the shaft.

8. The method of claim 7, wherein the step of preparing the shaft further comprises machining a key element receiver into the shoulder to receive the spacer keying element.

9. The method of claim 1, wherein the shoulder has a surface area and the axial bearing face includes an effective surface area about 130% to about 220% greater than the contact surface area.

10. A kit for retrofitting an oscillation joint for a tandem drive assembly having a shaft to provide an increased wear life, the kit comprising:
a spacer comprising an annular shape, a throughbore centered about an axis, a stop face extending a first radial height perpendicular to the axis, and an axial contact face disposed opposite the stop surface extending a second radial height perpendicular to the axis, the second radial height greater than the first radial height;
an inboard thrust bearing comprising an inner diameter, an outer diameter, and an axial bearing face, wherein a distance between the inner diameter and outer diameter is substantially similar to the second radial height; and
an outboard thrust substantially similar to the inboard thrust bearing.

11. The kit of claim 11 further comprising one or more ring bearings comprising a cylindrical tube including an inner surface with an inner diameter sized to fit over the shaft of the oscillation joint and an outer surface disposed opposite the inner surface.

12. The kit of claim 10 further comprising an oscillating hub comprising a throughbore, the inner surface of the throughbore comprising a cylindrical central portion sized to rotate about the one or more ring bearings, an inboard facing surface projecting radially from the central portion to abut an outboard facing side of the inboard thrust bearing, and an outboard facing surface projecting radially from the central portion and directed away from the inboard facing surface.

13. The kit of claim 12, wherein the inboard facing surface and outboard facing surface of the replacement oscillating hub each have a radial height substantially similar to the second radial height.

14. The kit of claim 10 further comprising a mounting plate comprising an inboard facing surface sized and adapted for facing an end surface of the shaft and an outboard facing surface of the outboard thrust bearing, and one or more mounting holes for fixing the mounting plate to the end of the shaft.

15. The kit of claim 10, wherein the axial face comprises a bearing surface having an effective surface area and wherein the ratio of the inner diameter to the surface area is about 1:50 to about 1:168.

16. The kit of claim 10, wherein the inner diameter is about 225 mm to about 725 mm and the effective surface area is about 11,310 mm² to about 121,737 mm².

17. The kit of claim 10, wherein the spacer further comprises a keying element for preventing rotation of the spacer relative to the shaft.

18. The kit of claim 17, wherein the keying element may be a projection or a detent.
